(19) United States
(12) Patent Application Publication
(10) Pub. No.: US 2004/0157591 A1
(43) Pub. Date: Aug. 12, 2004

(54) System and method for identifying and locating an identity

(76) Inventors: Yuan-Ying Hsu, Hsinchu Hsien (TW); Shuo-Wei Fang, Taoyuan Hsien (TW); Chien-Chao Tseng, Hsinchu Hsien (TW)

Correspondence Address: BIRCH STEWART KOLASCH & BIRCH, PO BOX 747, FALLS CHURCH, VA, 22040-0747, US

(21) Appl. No.: 10/759,422

(22) Filed: Jan. 20, 2004

(30) Foreign Application Priority Data
Oct. 11, 2002 (TW) 091123422

(51) Int. Cl. H04M 15/06

(52) U.S. Cl. 455/415; 379/142.01

(57) ABSTRACT

A system for identifying and locating an identity (ID) and the method thereof are disclosed. An ID processing unit receives an ID code from an ID unit and identify its ID. A delay time is estimated according to the received ID code, so that the location of the ID in a store. This enables a service representative to know which customers are in a nearby area in advance. The service representative can further look up the customer data from a customer database in order to provide better, personalized services for customers.

### BACKGROUND OF THE INVENTION

1. Field of Invention

The invention relates to a system and method for identifying and locating an identity and, in particular, to a system and method for identifying a person and locating the position thereof in a three-dimensional space.

2. Related Art

In developed countries, service businesses play an important role in their economic development. Therefore, management of service businesses is of great consequence in such countries. In general, service businesses can be categorized as consumption services, production services, distribution services, and non-profit/government services. Although visible product marketing and invisible service marketing are basically the same, both of which having the ultimate goal of satisfying customers' and consumers' needs, the service businesses are still special due to the difference between the features of services and the consumption decision process.

A marketing pattern that has been vividly discussed in recent years is the so-called interactive marketing. This refers to the interactive behavior that the first-line service representatives provide services from the viewpoint of the customers. The key factor for superior services is good, friendly and high-quality interactions between the service representatives and the customers because most services are provided via the service representatives. The consumer's expectation of services mainly comes from four respects: the first is the recommendation from relatives and friends, the second is his or her own experience, the third is personal standards, and the last is the service standards claimed on various media by the companies.

It is obviously seen that the most important factor in the service quality is the direct interactions between the service company and customers. This is because the customer only has a certain expectation before being serviced. The customer's real feeling starts from the moment he or she receives services from the company.

Theoretically speaking, the interactive marketing involves two issues: the technical quality and the functional quality. The technical quality refers to the service results that the customer receives, whereas the service quality refers to the process that the customer is serviced. The technical quality is mainly controlled by the hardware equipment, such as computerized systems and machines, in the company. The functional quality is how the company services the customers. It is about the attitude, behavior and conscience of the service representative toward the customers. In summary, it has become an important subject for a service business to improve its service quality by developing an ID recognition and locating system and the method thereof that helps the company provide services according to the customer's identity, consumption behavior and his/her location in the store.

### SUMMARY OF THE INVENTION

In view of the foregoing, a primary objective of the invention is to provide an ID recognition and locating system and the method thereof. The invention is used to identify the ID of customers and service representatives in a store. With the receivers installed in the store and the computation of a server, the positions of the customers and service representatives can be located.

Another objective of the invention is to provide an ID recognition and locating system and the method thereof in order to provide a better service quality. After the system identifies a customer and a service representative and their respective positions in a store, the customer's identity and relative position is sent to the service representative. The service representative is thus able to know who the customers in a near-by area are. He/she can further look up the customer-related data from a server in order to understand the customers better. This is very useful in providing better, personalized services to the customers.

A further objective of the invention is to provide an ID recognition and locating system and method with interactive effects. The store is installed with a bulletin board, which contains a receiver. After the recognition and locating system identifies the identity and finds the location of a customer, the customer identity and position are sent to the bulletin board. When the customer approaches, the bulletin board immediately displays relevant advertisement or discount information.

To achieve the above objectives, the disclosed identity recognition and locating system contains an ID unit, an ID processing unit and a server.

The ID unit stores an ID code held by a person, who can be a service representative or a customer. The ID unit transmits the ID codes periodically. After the ID processing unit receives an ID code, it computes the distance from the ID processing unit and the ID unit.

The ID processing unit sends the received ID code and the computed distance to the server. The server computes using the received distance to find out the position of the customer or service representative in the store.

Once the positions of the customer and service representative in the store are found out, the server sends the ID codes of the customers near a representative to the service representative. According to the received customer ID codes, the service representative can find relevant data in a customer information database. Such data include the name, birthday, habits, and consumption behavior, so that the service representative can understand basic data of the customer before providing services.

### BRIEF DESCRIPTION OF THE DRAWINGS

The invention will become more fully understood from the detailed description given hereinbelow illustration only, and thus are not limitative of the present invention, and wherein:

FIG. 1 is a functional block diagram of the disclosed ID recognition and locating system;

FIG. 2A is a main flowchart of the ID recognition and locating method;

FIG. 2B shows the operational flowchart of the server once the positions of the customers and service representatives are determined;

FIG. 3 shows a preferred embodiment of the disclosed system; and

FIG. 4 is a schematic view of a customer ID code displayed in an electronic device held or worn by a service representative.

### DETAILED DESCRIPTION OF THE INVENTION

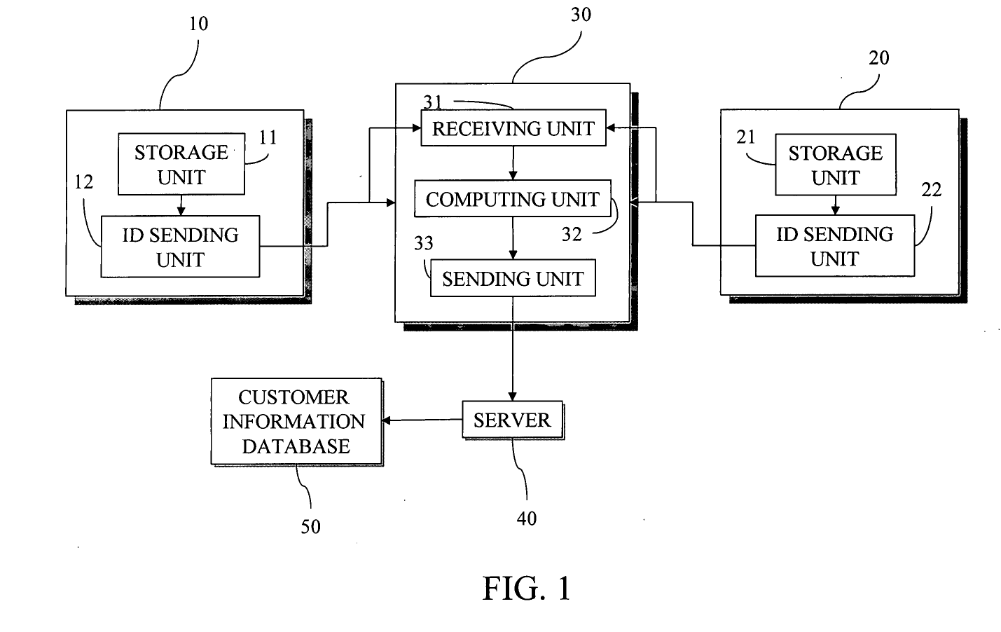

With reference to FIG. 1, the disclosed identity recognition and locating system includes a customer ID unit 10, a service representative ID unit 20, and an ID processing unit 30.

The storage unit 11 of the customer ID unit 10 is stored with a customer ID code. The storage unit 21 of the service representative ID unit is stored with a service representative ID code. The ID processing unit 30 contains at least one receiving unit 31, a computing unit 32, and a sending unit 33.

The customer ID 10 sends a customer ID code via the ID sending unit 12 periodically. The service representative ID unit 20 also sends a service representative ID code via the ID sending unit 22 periodically. The ID processing unit 30 receives the customer ID code and the service representative ID code using the receiving unit 31. The customer ID unit 10, the service representative ID unit 20, and the ID processing unit 30 can use the RFID mechanism provided by Texas Instruments, Inc or other similar mechanisms. After the ID unit 20 receives the ID codes, the computing unit 32 computes the distance from the ID processing unit 30 to the customer ID unit 10 and the service representative ID unit 20. The distance thus computed is encoded in order into customer distance signals and service representative distance signals.

The sending unit 33 of the ID processing unit 30 sends the encoded customer ID signals, service representative ID signals, and the computed customer distance signal, service representative distance signal to the server 40 through an existing wired network or in a wireless method. The server 40 then uses the customer distance signal or service representative distance signal to compute the positions of the customer and the service representative.

Once the positions are determined, the server 40 sends the data in wireless methods (e.g. a wireless LAN or Bluetooth network) to a service representative. The service representative can find out from a customer information database 50 the name, birthday, habits, and consumption behavior of a customer according to his/her ID code. This enables the service representative to provide better, personalized services to the customers.

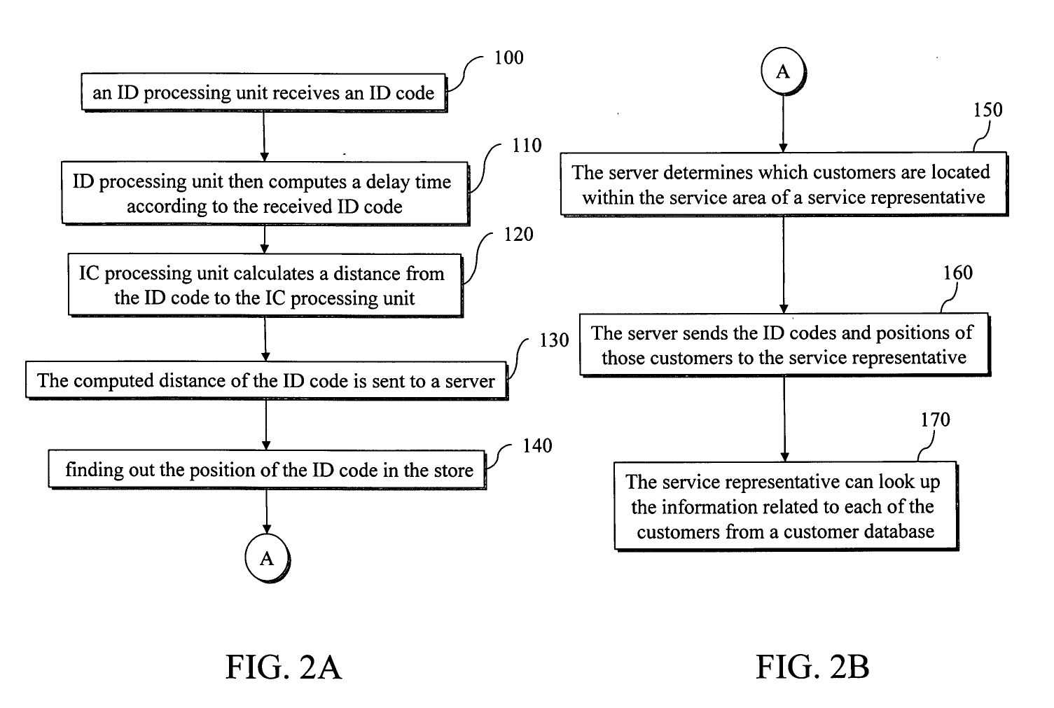

We show the main procedure of the disclosed method in FIG. 2A. First, an ID processing unit 30 receives an ID code (step 100), which can be a customer ID code from a customer ID unit 10 or a service representative ID code from a service representative ID unit 20. The ID processing unit 30 then computes a delay time according to the received ID code (step 110). It further calculates a distance from the ID code to the IC processing unit 30 (step 120). The computed distance of the ID code is sent to a server (step 130) for finding out the position of the ID code in the store (step 140). This is the position of the customer or service representative in the store.

FIG. 2B shows the procedure of the method after the positions are determined. The server determines which customers are located within the service area of a service representative (step 150), and sends the ID codes and positions of those customers to the service representative (step 160). Therefore, the service representative can know all customers in his/her service area and their relative positions. The service representative can further look up the information related to each of the customers from a customer database (step 170) in order to provide personalized services.

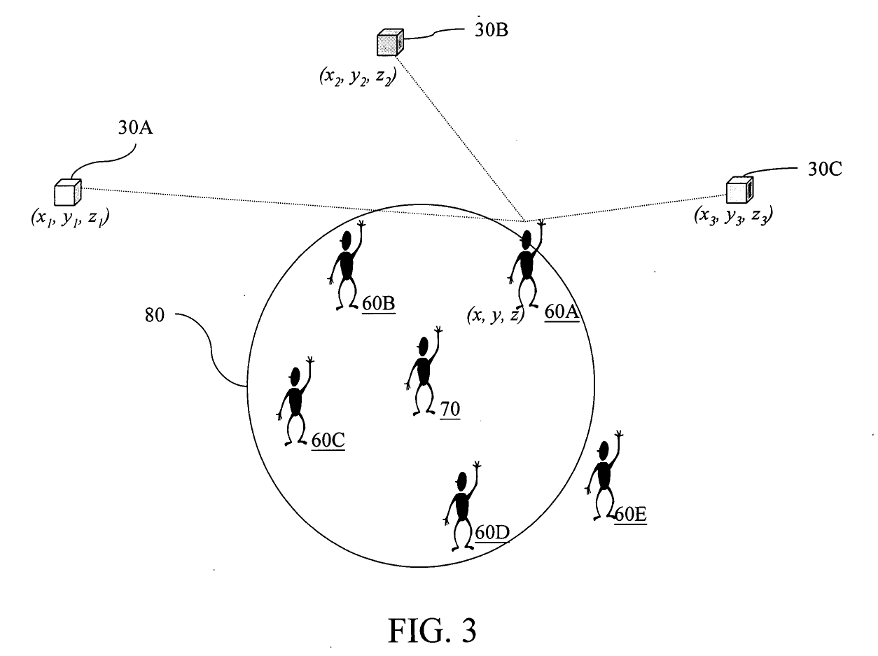

Please refer to FIG. 3, where we use an embodiment to demonstrate the implementation of the invention. Each customer coming to the store is given a customer ID unit 10. Suppose a customer 60A comes to the store and is given a customer ID unit 10A (not shown). Here and in the following figures, the label A means that it is held by the customer 60A. Such a customer ID unit 10A can be clothes, decoration, card, key holder, or any object that a chip can be put in.

The store is installed with at least three ID processing unit: a first ID processing unit 30A, a second ID processing unit 30B, and a third ID processing unit 30C. Relative to the store, the first ID processing unit 30A is located at a coordinate (x1,y1,z1), the second ID processing unit 30B at (x2,y2,z2), and the third ID processing unit 30C at (x3,y3,z3).

When the customer 60 A, with a coordinate (x,y,z), walks into the store, the first ID processing unit 30A, the second ID processing unit 30B, and the third ID processing unit 30C receive the customer ID code from the customer ID unit 10A. When the first ID processing unit 30A receives the customer ID code, it estimates a delay time T1, from which one is able to obtain a distance D1 between the customer 60A and the first ID processing unit 30A by multiplying the speed of the radio wave.

Similarly, when the second ID processing unit 30B and the third ID processing unit 30C receive the customer ID code, they also estimates delay times T2 and T3, respectively. From these delay times T2 and T3, distances D2, D3 from the customer 60A to the second ID processing unit 30B and the third ID processing unit 30C are obtained.

Once the distance D1 is figured out, the customer ID code and the distance D1 are sent by the first ID processing unit 30A to the server 40. After the server 40 also receives the customer ID code and the distance D2, D3 sent from the second ID processing unit 30B and the third ID processing unit 30C, it starts to locate the position of the customer in the store.

The actual position of the customer 60A in the store is computed by simultaneously solving the three equations: D₁=\sqrt{(x−x₁)²+(y−y₁)²+(z−z₁)²}, D₂=\sqrt{(x−x₂)²+(y−y₂)²+(z−z₂)²}, and D₃=\sqrt{(x−x₃)²+(y−y₃)²+(z−z₃)²}. The position of any service representative 70 in the store is also computed in the same way.

Each service representative 70 in the store holds or wears an electronic device (not shown). The service representative ID unit 20 can be installed inside the electronic device or can be the same type as for the customers. The hand-held electronic device can be a personal digital assistant (PDA), a mobile phone, a pocket PC, or any other portable device that can process data.

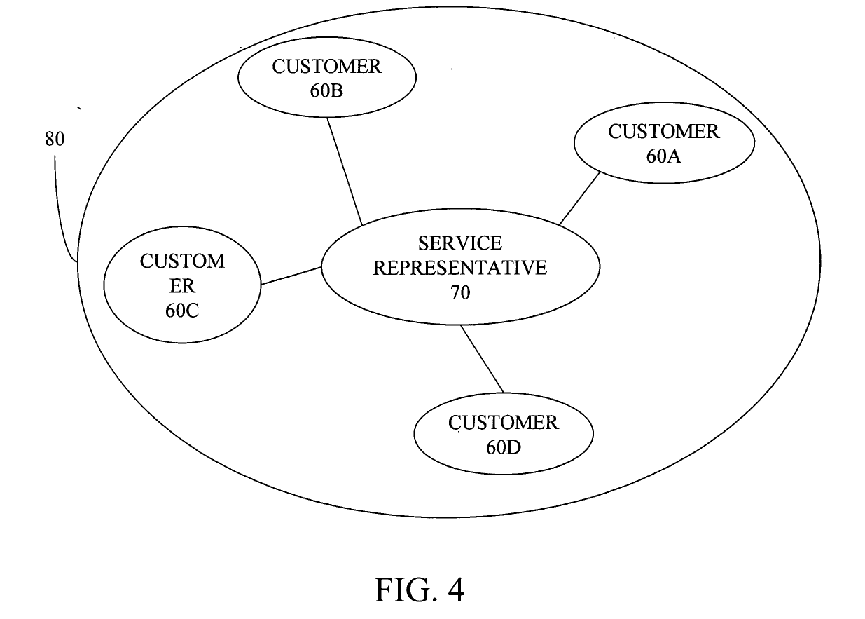

The service area 80 of the service representative 70 is shown in FIG. 3. After the server (not shown in FIG. 3) computes the positions of the service representative 80 and the customers 60A, 60B, 60C, 60D, 60E, the customer ID codes of the customers falling in the service area 80 are sent to the electronic device of the service representative 70. In FIG. 3, the customers in the service area 80 of the service representative 70 are customers 60A, 60B, 60C, 60D. Therefore, the server 40 sends the customer ID codes and positions of them to the electronic device held or worn by the service representative 70. The relative positions of the customers 60A, 60B, 60C, 60D to the service representative 70 are displayed on the electronic device, as shown in FIG. 4. The service representative 70 can first select a customer, the customer 60C for example. Before introducing products to the customer 60C, the service representative 70 can look up his/her basic data from a customer information database 50 via the server 40. Such data include the name, birthday, habits, favorite colors, etc. Thus, the service representative 70 can provide products preferred by the customer 60C better.

The invention can also be used in broadcasting advertisement information. A server is installed in a three-dimensional space. The server also identifies and locates a customer using the disclosed system and method. Different information is then sent according to different customers. For example, a bulletin board is installed in the store. When the server detects that a customer is approaching the bulletin board, it can send a greeting message to the customer and contents or product introductions that the customer may like to see the most. Moreover, the price of a product can be displayed according to different customers.

The disclosed system and method can be used in boutiques, hotels, restaurants, convenience stores, wholesalers, shopping centers, etc. Service representatives can use the information provided by the invention to provide customers with personalized services and keep better relations with the customers.

Effects of the Invention

The disclosed ID recognition and locating system and the method thereof use an ID processing unit to receive and identify the ID code from a customer ID unit. The received ID code is further used to calculate the position of the customer in the store. With a database that stores customer information, the service representative can know in advance the detailed information of a customer in his/her service area for providing better, personalized services.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An identity (ID) recognition and locating system for determining the identity and position of a person in three-dimensional space, the system comprising:
an ID unit, which stores an ID code;
at least three ID processing units, which receive the ID code and, after receiving the ID code, compute the distances from the ID unit to the ID processing units, respectively; and
a server, which computes the coordinate of the ID unit in the three-dimensional space according to the distances from the ID unit to the ID processing units.

2. The system of claim 1, wherein the ID unit further comprises:
a storage unit, which stores the ID code; and
a sending unit, which sends the ID code.

3. The system of claim 1, wherein ID processing unit comprises:
a receiving unit, which receives the ID code;
a computing unit, which computes the distance between the ID unit and the ID processing unit according to the ID code; and
a sending unit, which sends the ID code and the distance between the ID unit and the ID processing unit to the server.

4. The system of claim 1, wherein the ID processing unit estimates a delay time after receiving the ID code.

5. The system of claim 4, wherein the delay time is used to compute the distance from the ID unit to the ID processing unit.

6. The system of claim 5, wherein the distance from the ID unit to the ID processing unit is computed by multiplying the delay time of the ID code with the speed of radio waves.

7. The system of claim 1, wherein the ID unit is held by each of the customer and service representatives.

8. The system of claim 7, wherein after computing the three-dimensional coordinates of the ID units the server further sends a service representative the customer ID codes and coordinates of those who are in his/her service area.

9. The system of claim 7, wherein the customer ID codes of the customers in the service area of a service representative are displayed on a hand-held electronic device.

10. The system of claim 7, wherein the customer ID codes of the customers in the service area of a service representative are displayed on a wearing electronic device.

11. The system of claim 7, wherein the service representative uses the received customer ID code to look up information related to a customer from a customer information database via the server.

12. An ID recognition and locating method for determining the identity and position of a person in three-dimensional space, the method comprising the steps of:
using an ID processing unit to receive an ID code;
estimating a delay time according to the received ID code;
using the ID processing unit to compute the distance from the ID code to the ID processing unit using the delay time; and
using a server to compute the position of the ID code in the three-dimensional space.

13. The method of claim 12, wherein the distance is transmitted to the server in a wireless method.

14. The method of claim 12, wherein the distance is computed by multiplying the delay time with the speed of radio waves.

15. The method of claim 12, wherein the IC code is sent from an ID unit.

16. The method of claim 15, wherein the ID unit is held by each of the customers and service representatives.
